(19) United States
(12) Patent Application Publication
(10) Pub. No.: US 2011/0166848 A1
(43) Pub. Date: Jul. 7, 2011

(54) METHOD AND SYSTEM FOR MODELLING WATER TREATMENT AND HARVESTING

(75) Inventors: David Thomas McCarthy, Victoria (AU); Ana Deletic, Victoria (AU); Timothy David Fletcher, Victoria (AU)

(73) Assignee: Water Harvesting Technologies Pty Ltd., Castlemane (AU)

(21) Appl. No.: 13/000,810

(22) PCT Filed: Jun. 24, 2009
(86) PCT No.: PCT/AU2009/000808

§ 371 Date: Mar. 22, 2011

(30) Foreign Application Priority Data
Jun. 24, 2008 (AU) 2008903208

(51) Int. Cl. G06F 9/455

(52) U.S. Cl. 703/22

(57) ABSTRACT

A method of modelling a water harvesting and treatment system, the method comprising: receiving modelling data, the modelling data comprising a plurality of parameters relating to intended application of the water harvesting and treatment system; accessing rainfall data for a geographic region for a predetermined historical period, the rainfall data comprising data for a plurality of predetermined time increments over the historical period; and generating a model of the water harvesting and treatment system based on the rainfall data and the modelling data.

### TECHNICAL FIELD

The described embodiments relate to methods and systems for modelling water treatment and harvesting.

### BACKGROUND

Many populated areas rely on supply of water from a large water reservoir fed by rain falling on a catchment area that drains into the reservoir. As weather patterns vary from year to year and season to season, the amount of water in the reservoir varies. Additionally, the rate at which water in the reservoir is consumed by the public can vary from season to season. In areas that experience prolonged drought, management of water supply reserves attracts much public interest and concern.

Much rain water can be lost to the environment and may fall on areas that do not form part of the catchment area for a public reservoir.

It is desired to address or ameliorate one or more shortcomings or disadvantages associated with existing water harvesting techniques, or to at least provide a useful alternative thereto.

### SUMMARY

Certain embodiments relate to a method of modelling a water treatment and harvesting system. The method comprises:
receiving modelling data, the modelling data comprising a plurality of parameters relating to intended application of the water treatment and harvesting system;
accessing rainfall data for a geographic region for a predetermined historical period, the rainfall data comprising data for a plurality of predetermined time increments over the historical period; and
generating a model of the water treatment and harvesting system based on the rainfall data and the modelling data.

The method may further comprise automatically adjusting at least one parameter of the modelling data and generating a next model of the water treatment and harvesting system based on the rainfall data and the adjusted modelling data. The plurality of parameters may comprise a first parameter and a second parameter and the adjusting may comprise adjusting one of the first parameter and the second parameter. The adjusting and generating may be repeatedly performed a predetermined number of times.

The modelling may be based on an urbanised water catchment area. The urbanised water catchment area may comprise a relatively high proportion of impervious surfaces. The proportion of impervious surfaces may comprise greater than 5% of the water catchment area.

The generating may comprise determining flow and pollutant concentrations for rainfall modelled to be received at the treatment and harvesting system at each time point. The generating may further comprise determining capture and treatment efficiency for rainfall modelled to be received at a filter of the treatment and harvesting system at each time point. The generating may further comprise determining a storage efficiency of a water storage structure of the treatment and harvesting system.

The adjusting and generating may comprise adjusting the first parameter and generating a next model based on the adjusted first parameter for a first predetermined number of iterations and then adjusting the second parameter and generating a next model based on the adjusted second parameter. The adjusting of the second parameter and the generating a next model may be performed for a second predetermined number of iterations. The first predetermined number of iterations may be performed for each of the second predetermined number of iterations.

The method may further comprise displaying a comparative display of the model and at least one next model generated based on the same rainfall data. The comparative display may comprise at least one of: a comparison of filter cost and filter efficiency; a comparison of filter size and filter efficiency; a comparison of storage cost and storage efficiency; and a comparison of storage size and storage efficiency.

Other embodiments relate to a system for modelling a water treatment and harvesting system. The system comprises an interface for receiving modelling data comprising a plurality of parameters relating to intended application of the water treatment and harvesting system. The system further comprises at least one processing device having access to the modelling data and having access to rainfall data for a geographic region for a predetermined historical period, the rainfall data comprising data for a plurality of predetermined time points over the historical period. The system further comprises computer readable storage storing program code executable by the at least one processor for causing the at least one processor to generate a model of the water treatment and harvesting system based on the rainfall data and the modelling data.

The program code may comprise code which, when executed by the at least one processor, causes the at least one processor to execute at least one of: a user interface module; an iteration module; a rainfall run off determination module; a filter capture and treatment efficiency determination module; a storage efficiency module; and a decision support module.

The interface may be responsive to the at least one processor to display a comparative display of the model and at least one next model generated based on the same rainfall data. The comparative display may comprise at least one of: a comparison of filter cost and filter efficiency; a comparison of filter size and filter efficiency; a comparison of storage cost and storage efficiency; and a comparison of storage size and storage efficiency.

Further embodiments relate to computer readable storage storing program code which, when executed by at least one processor, causes the at least one processor to perform any of the methods described above.

### BRIEF DESCRIPTION OF THE DRAWINGS

Embodiments are described in further detail below, by way of example, with reference to the accompanying drawings, in which:

FIG. 1 is a block diagram of a system for modelling a water treatment and harvesting system;

FIG. 2 is a block diagram of modules of the modelling system;

FIG. 3 is a flowchart of a method of modelling a water treatment and harvesting system;

FIG. 4 is a flowchart of an iteration process of the method of FIG. 3;

FIG. 5 is a flowchart of a process for modelling capture of rainfall within a catchment area;

FIG. 6 is a flowchart of a process for modelling a filter efficiency of a filter system of the water treatment and harvesting system;

FIG. 7 is a flowchart of a process for modelling storage efficiency of a storage system of the water treatment and harvesting system;

FIG. 8 is a block diagram of an example water treatment and harvesting system;

FIG. 9 is a plot of example modelled parameters of a water treatment and harvesting system;

FIG. 10 is a plot of further example modelled parameters of a water treatment and harvesting system; and

FIG. 11 is a plot of further example modelled parameters of a water treatment and harvesting system.

### DETAILED DESCRIPTION

The described embodiments relate generally to methods and systems for modelling water treatment and harvesting for an urban rain water harvesting system. The water harvesting system may be small-scale, such as for domestic or small urban industrial applications. Alternatively, embodiments may be applied to larger-scale water harvesting applications, such as for municipalities, townships or large industrial applications.

In the context of the present application, the term rainfall is used herein to describe any form of precipitation that can be stored in the form of water, for example including hail, rain, dew, condensation and snow. In this context, all such precipitation is considered to constitute rainfall, so long as it can be measured by instrumentation commonly used to measure rainfall. Among some persons skilled in the art of water harvesting, a distinction is made between rainwater and stormwater, where rainwater is considered to be that water which falls on the roof of a structure and is collected directly from that roof, while stormwater is considered to be that water which falls on surfaces, such as roads or other land surfaces, and commonly finds its way into drainage structures. For present purposes, no such distinction is made between these sources of water and both such sources are considered to be sources of water resulting from rainfall.

The described embodiments can be applied to the design of a range of water treatment and/or harvesting systems, at a range of scales. For example, the described embodiments can be used to determine the appropriate size of a filter module to be placed on the inlet of an existing tank, used to store rainwater from a roof. Similarly, the described embodiments can be used to size both the filter and tank. The described embodiments can equally be applied to size a filter system to treat urban rainwater from a carpark area, and to size a tank or other storage type to store that treated water for subsequent reuse. Another application may be for the design of a municipal-scale distributed water treatment and harvesting system, which may involve the installation of a specifically-sized filter at each existing water drainage pit, and for the design and sizing of a store or stores to harvest and distribute that water for reuse.

Embodiments generally employ historical rainfall and other climatic data (including rainfall rates, evaporation rates and temperatures), in combination with a series of modelling parameters relating to intended application of the water harvesting system. For example, such parameters may include historical or intended water consumption, size of catchment area, size of filtration system, size of storage tank (volume and surface area) and/or other environmental data relating to the local environment around the water harvesting system. Some described embodiments employ an iterative process to generate a series of models of the water harvesting system based on one or more varied parameters to provide a comparative analysis of the plurality of models.

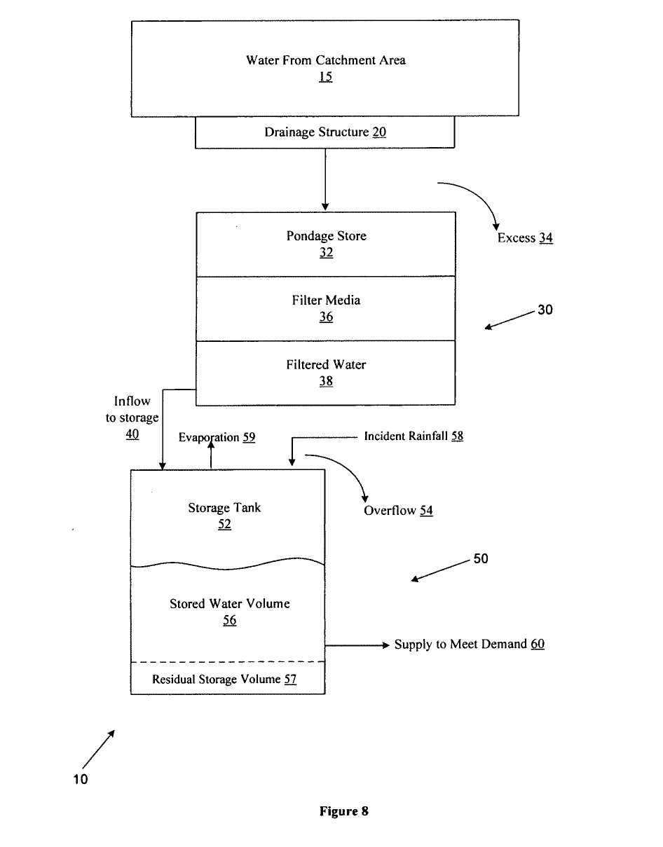

An example water treatment and harvesting system 10 is illustrated in FIG. 8. System 10 comprises a filtration system 30 that receives water from a catchment area 15 through a natural and/or artificial drainage structure 20. Drainage structure 20 may comprise gutters or other structures tending to collect running water, for example. System 10 also comprises a storage system 50 for storing water received through the filtration system 30 and providing a supply 60 to meet demand.

The filtration system 30 may comprise a suitable containing structure (not shown) to house filter media 36 for filtering water received through drainage structure 20. Filtration system 30 may comprise a pondage store 32 of a predetermined volume to act as a storage buffer for water to be filtered through filter media 36. The pondage store 32 is defined by the containing structure and is positioned adjacent or near the filter media 36 and in fluid communication therewith to allow water from the pondage store 32 to flow through the filter media 36. Specifically, pondage store 32 may be above, below or to the side of filter media 36. When pondage store 32 is full, further water received from drainage structure 20 is drained off as excess water 34 and is thus lost to system 10. Water filtered through filter media 36 may be temporarily stored as filtered water 38 within filtration system 30 before being provided as in-flow 40 to storage system 50. The water quality of water passing through the filter media 36 may be changed, for example by removal of pollutants or contaminants, through the action of the filter media 36.

Storage system 50 comprises a storage tank or reservoir 52 having an available stored water volume 56 within the tank above a residual storage volume 57. The residual storage volume 57 may be a mandated minimum water level for the tank or reservoir 52. The storage tank or reservoir 52 may comprise any suitably shaped and sized water storage structure, including earthen, plastic, clay, metal, stone or other structures, but for convenient reference will be referred to as tank 52.

When storage tank 52 is full, in-flow 40 is drained away as over-flow water 54 and is lost to system 10. The available stored water volume 56 is used to provide the water supply 60 to meet the water demand on the system 10. If the available stored water volume 56 is less than or equal to the residual storage volume 57, then none of the water within the tank 52 is available for use. This residual storage volume 57 may be used for open ponds where the residual storage is used for amenity purposes and water levels should be maintained above a certain height, for example.

Supply 60 may be relied upon as the sole source of water supply to meet the demand or may be used to supplement other water sources in meeting demand.

Tank 52 may also have a surface area which is open to the atmosphere, with this area having incident rainfall 58 that passes into the tank 52 and direct evaporation 59 from the tank 52.

Water quality in the storage system 50 may be modelled to change with time. For example, the quality of water remaining in storage tank 52 for an extended period may be modelled to decrease.

Water harvesting system 10 may comprise multiple storage systems 50, multiple filtration systems 30 and harvest water from multiple drainage structures 70.

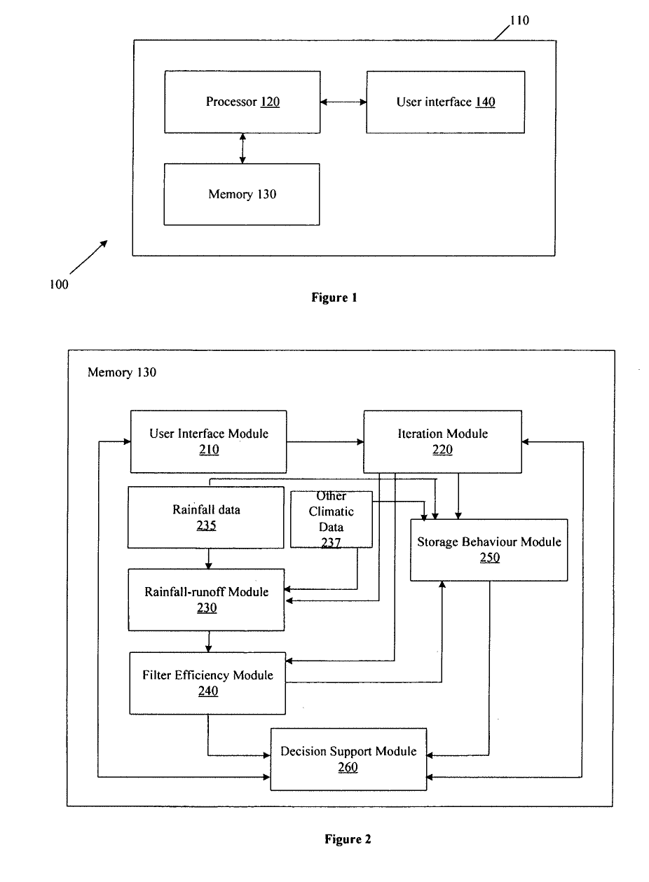

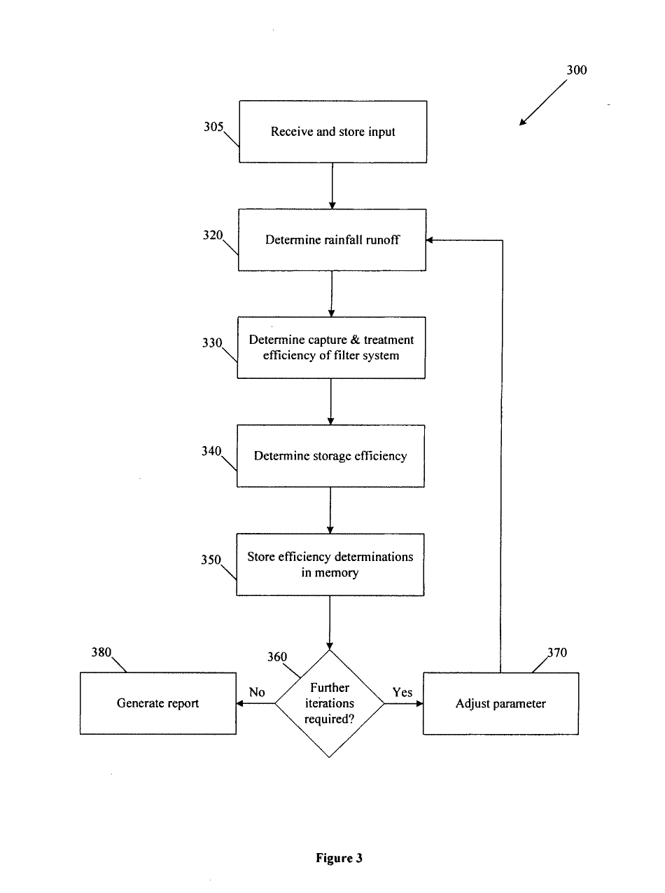

Depending on the demand which water harvesting system 10 is intended to meet or the required pollutant treatment effectiveness, as well as environmental and cost factors, the size and/or configuration of filtration system 30 and storage system 50 may need to be optimised. Such optimisation can be rather complicated, and thus the modelling system described below in relation to FIGS. 1 and 2 and the modelling processes described below in relation to FIGS. 3 to 7 can be employed to assist in determining an optimal configuration for water treatment and harvesting system 10.

Referring now to FIG. 1, there is shown a system 100 for modelling a water harvesting system, such as system 10. System 100 comprises a computing system 110 having a processor 120, a memory 130 and a user interface 140. Computing system 110 may comprise a personal computer, a server system or a combination of distributed computing devices, for example. Processor 120 may comprise a single processing device or multiple processing devices, either within a single computing device or distributed across multiple computing devices. Processor 120 has access to memory 130.

Memory 130 may be partly or wholly physically located within or associated with the computing system 110 or may be partly or wholly associated with or distributed across multiple computing devices that may be physically distinct from computing devices in which processor 120 may be located. Memory 130 may comprise different forms of computer readable storage, at least some of which should comprise a non-volatile store for storing program code.

User interface 140 may comprise usual computer peripheral devices, such as a display (not shown), key board or touch screen (not shown) and/or a mouse (not shown), for example.

System 100 may be embodied as a computerised kiosk, for example, such as may be used in a retail establishment, such as a hardware store or a store specialising in water treatment and/or harvesting products. The kiosk may be located in the retail establishment so as to be accessible to the public, for example. Alternatively, system 100 may be employed as a planning tool within a business that offers water treatment and harvesting planning services or installs water treatment and/or harvesting systems. Alternatively, system 100 may be employed in an application service provider model, for example, whereby system 100 can be accessed over a network as a planning or sales tool for water treatment and/or harvesting systems.

System 100 relies on access to rainfall data 235 and optionally other climatic data 237 (shown in FIG. 2) to simulate or model the water treatment and harvesting system 10 under certain rainfall (inflow) and demand (outflow) conditions. The rainfall data 235 and climatic data 237 for a number of geographic regions may be stored in memory 130 such that, when it is desired to model a water treatment and harvesting system to be located in one of those areas, the relevant data for that specific area can be accessed, for example by reference to a postal code, a zip code or an area code, and used by system 100 in performing the modelling. Alternatively, some or all of the rainfall data 235 and other climatic data 237 may be accessed from a central data repository over a network (not shown). As a further alternative, specific rainfall and/or other climatic data for a localised geographic area may be provided as input to system 100, for example where that data is stored on a transportable data storage medium.

System 100 also relies on modelling data in modelling the water treatment and harvesting system 10. Such modelling data is used to define relevant parameters concerning the catchment area 15, filter system 30 and storage system 50, as well as the water demand which the system 10 is to meet (including a demand pattern for a specific period of time, for example indicating higher and lower demands at different times during a 24 hour period, different days of the week, different months of the year and/or different years). Some parameters may be predetermined according to calculated or measured data, for example such as average pollutant concentrations in the relevant geographical area or average pollutant concentrations associated with particular catchment types or areas. Additionally, flow rates through one or more selectable types of filter media 36 may be predetermined, as well as the effectiveness of pollutant treatment of those types of filter media 36. Thus, the modelling data may be partly received as input solicited from a user and partly received by retrieval of preconfigured parameters stored in memory 130.

Throughout the modelling performed by system 100, memory 130 is used as a temporary data store to enable determinations and calculations based on the rainfall and climatic data 235, 237 and modelling data and memory 130 may also comprise non-volatile data storage for storing program code to perform the modelling as described herein. Memory 130 may also comprise other program code modules, such as operating system software, peripheral device drivers, etc. as necessary for proper operation of a computer system.

Referring also to FIG. 2, program code modules stored within memory 130 are described in further detail. Such program code modules include a user interface module 210, an iteration module 220, a rainfall runoff module 230, a filter efficiency module 240, a storage behaviour module 250 and a decision support module 260.

The user interface module 210 receives and stores inputs that describe a specific water treatment and harvesting scenario. User interface module 210 provides a graphical user interface via user interface 140. User interface module 210 receives output from the decision support module 260 regarding generated models of system 10 and also generates reports and information to guide a user with the selection and/or design of the water treatment and harvesting system.

User interface module 210 provides iteration module 220 with all the required input information so that the model can produce the required output information. Firstly, rainfall data 235 and other climatic data 237 is loaded based upon the user's inputs or is automatically accessed. The rainfall-runoff module 230 uses the rainfall data 235 and other climatic data 237 to determine the amount of water which (under simulation) runs from the catchment area to the filter system. For example, if system 10 is to be installed to harvest the water from a roof, the rainfall-runoff module 230 will use the rainfall data 235 and climatic data 237 to determine what volume and quality (including, but not limited to solids, nutrients, heavy metals, pathogens and hydrocarbons, collectively known as the water ‘quality’) of water comes from the roof and into the filter system 30.

The volume and quality of water which would have been produced by the catchment based on the known historical rainfall and other climatic data (as determined by rainfall runoff module 230) is simulated to be delivered to the filter system 30. Filter efficiency module 240 calculates (1) the amount and quality of water which would be processed by the filter and would enter the storage tank 52 and (2) the amount and quality of water which would not be processed by the filter and would not enter the storage tank 52. This determination requires receipt of the current value of the size (area) of filter media 36 from the iteration module 220. The filter efficiency module 240 reports the filter's capture and treatment efficiency to the decision support module 260.

The storage behaviour module 250 uses the data generated at the filter efficiency module 240 and the current value of the size of the storage tank 52 received from the iteration module 220 to determine relevant reliability-related information, for example such as what proportion of the user defined demand volume has been successfully delivered from the tank to meet that demand, and the quality of that water. The proportion of demand met (i.e. volumetric reliability-demand requested vs. demand met), as well as other information relating to the reliability of the store, such as a time-based reliability measure (i.e. number of days where demand was met vs. number of days where demand was requested), may be thus reported to the decision support module 260.

Once the filter efficiency module 240 and the storage behaviour module 250 have both completed their processing functions, the decision support module 260 sends the determined efficiency information to the iteration module 220. Iteration module 220 can then adjust one or more input parameters, including, for example: (1) the size (area) of the filter media 36; (2) the size of the tank 52; (3) the filtration rate of filter media 36; (4) the volume of pondage store 32; (5) the type of storage and/or wall material; (6) the area of storage open to the atmosphere; (7) the relative imperviousness of the catchment; (8) the routing coefficient; (9) residual storage volume; and (10) demand magnitude and/or pattern. Once the adjustments are made to the filter size or tank size (or other parameter), the process is repeated. Once the iteration process has gone through all parameter adjustments, effectively generating a model of system 10 for each parameter variation, decision support module 260 uses the models to generate a report to the user to indicate the specifications of a suitable water treatment and harvesting system via the user interface module 210 and user interface 140.

Decision support module 260 may also be used, in combination with user interface module 210 and user interface 140, to produce a life cycle costing analysis report for the user that details information about the costs of the system 10 (initial and continual, renewal etc.) over the projected life-span of the system 10. The report may also detail maintenance schedules for the replacement of the filter media and other components of the system 10. Software algorithms for generating such reports may be similar to those used in existing modelling software, such as MUSIC Version 4, available as of the date of filing this application at http://www.toolkit.net.au/Music.

Referring now to FIG. 3, a method 300 for modelling a water treatment and harvesting system, such as system 10, is described. Method 300 begins at step 305, at which parameters relating to intended application of the water treatment and harvesting system are received, for example via user interface 140 or from memory 130 (for pre-configured parameters). Receipt of input parameters includes receipt as input via user interface 140 and retrieval of parameters stored in memory 130. Such received parameters include, for example: the surface area of catchment area 15; a measure or estimate of the relative imperviousness of the surface of catchment area 15; a routing coefficient representative of the path or distance that accumulated rainfall must travel to reach the drainage structure 20; an estimated rate of evaporation (if historical evaporation rates are not available); an estimated initial loss or depression storage volume representative of the amount of rainfall retained in the surface structure of the catchment area 15; a type or composition of the filter media 36; size of the filter area, for example in square metres; an initial filtration or processing rate of the filter media 36; a pondage depth (or volume) of the pondage store 32; a maximum volume of the storage tank 52; the residual storage volume 57 of the storage tank 52; the surface area of the storage tank 52 open to the atmosphere; a required supply to meet demand 60 and a pattern of the demand; a required storage efficiency; and a required filter efficiency. Further parameters and/or variables may be calculated, determined or assigned as may be desirable or necessary for performing the modelling. For example, an input parameter specifying a demand of 10,000 litres per month may be broken down into a smaller demand amount corresponding to the size of the timestep Δt of the rainfall data points and then these smaller demand amounts may be spread across a 24 hour period (or another specific time period) according to the specified demand pattern.

Also at step 305, rainfall runoff module 230 loads rainfall data 235 and other climatic data 237 as a series of data points separated by a constant time interval, such as one or six minutes. The rainfall data may be a general, or average, rainfall for a larger area or region within which the specific area of interest (i.e. the location of the catchment area 15) is located. Alternatively, where available, rainfall data for a more localised or specific area of interest may be used. The extent of the historical rainfall data 235 may vary, depending on location and availability of the data. The user interface module 120 may provide the option of selecting certain periods of the available rainfall data 235 and other climatic data 237 for a specific location. Historical periods for which this type of data is obtained or obtainable may range from just one year to, perhaps, several hundred years.

Depending on the frequency of measurement of rainfall in the selected area, less than all of the rainfall data may be used to perform the water harvesting modelling. For example, where an area is known to have very low rainfall, a large majority of the data points may indicate no rainfall. Thus, processing all rainfall data, including a large number of zero rainfall data points, may be less efficient than processing a subset of the rainfall data points, for example only those data points indicating a non zero rainfall or processing every second, third, fourth or n^{th} rainfall data point.

For each rainfall data point processed, its time difference between neighbouring processed rainfall data points must be known in order to be able to model in-flow, storage efficiency and filter efficiency. For ease of description of the modelling method and system embodiments, the rainfall data points will be assumed to start at a data point t=1 and end at t=N, with a constant time period, Δt, between data points.

As described herein, rainfall-runoff module 230, filter efficiency module 240 and storage behaviour module 250 each perform processes in relation to the selected full set or partial set of rainfall data points before passing process control to a next module. This is because one module may rely on calculations and/or determinations made by a previous module in relation to each data point. Thus, for example, rainfall module 230 processes all rainfall data 235 for a selected historical period and saves calculations and/or determinations in memory 130 before passing process control to filter efficiency module 240. Filter efficiency module 240 then accesses the calculations and/or determinations made by rainfall module 230 as necessary, while accessing the rainfall data 235 if necessary, at each time step (i.e. t=1 to N).

At step 320, the rainfall runoff and its quality is determined by rainfall-runoff module 230 based on the rainfall data 235, the catchment area and type, the determined depression storage, an estimated evaporation rate or historical evaporation rate from climatic data 237, the amount of water in transit and other environmental factors relating to catchment area 15 and drainage structure 20 such as pollutants (including but not limited to solids, nutrients, heavy metals, hydrocarbons and pathogens). Using the input rainfall data 235, rainfall runoff module 230 calculates the volume and quality of water which flows from the user specified catchment area 15 by taking into account the type, and the relative proportions, of different surfaces within the catchment area 15 (e.g. paved, roofed, grass, etc). For urbanised catchment areas, a relatively high proportion (e.g. greater than about 5%) of the surfaces is impervious.

Also at step 320, the quality of the rainfall runoff water (as assessed relative to a number of possible contaminants, including, but not limited to, solids, nutrients, heavy metals, hydrocarbons and pathogens) may be predicted by one of three methods: (i) application of a static mean water quality value for the area in which catchment area 15 is located; (ii) stochastic generation based on a defined mean and standard deviation water quality concentration; and (iii) calculation of the water quality as a function of variables such as rainfall intensity, flow rate and catchment type, along with build-up and wash-off processes. Step 320 is described in further detail below, with reference to FIG. 5.

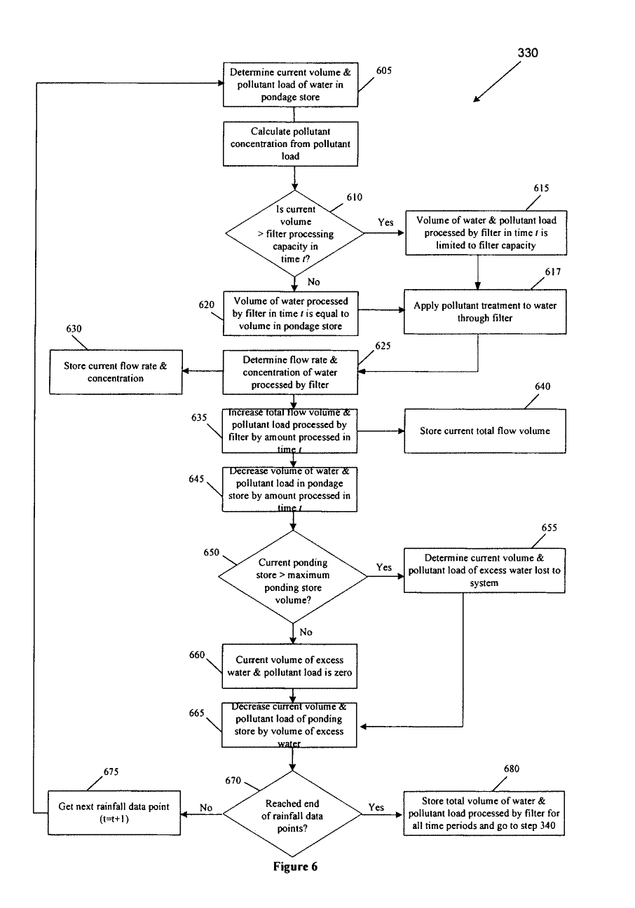

At step 330, the capture and treatment efficiency of filtration system 30 is determined by filter efficiency module 240. This determination is made on the basis of the determined runoff (i.e. water received at filtration system 30 via drainage structure 20), as well as the size of the ponding store, the type and the processing capacity of the filter media 36 and the filter media area, for example. Step 330 is described in further detail below, with reference to FIG. 6.

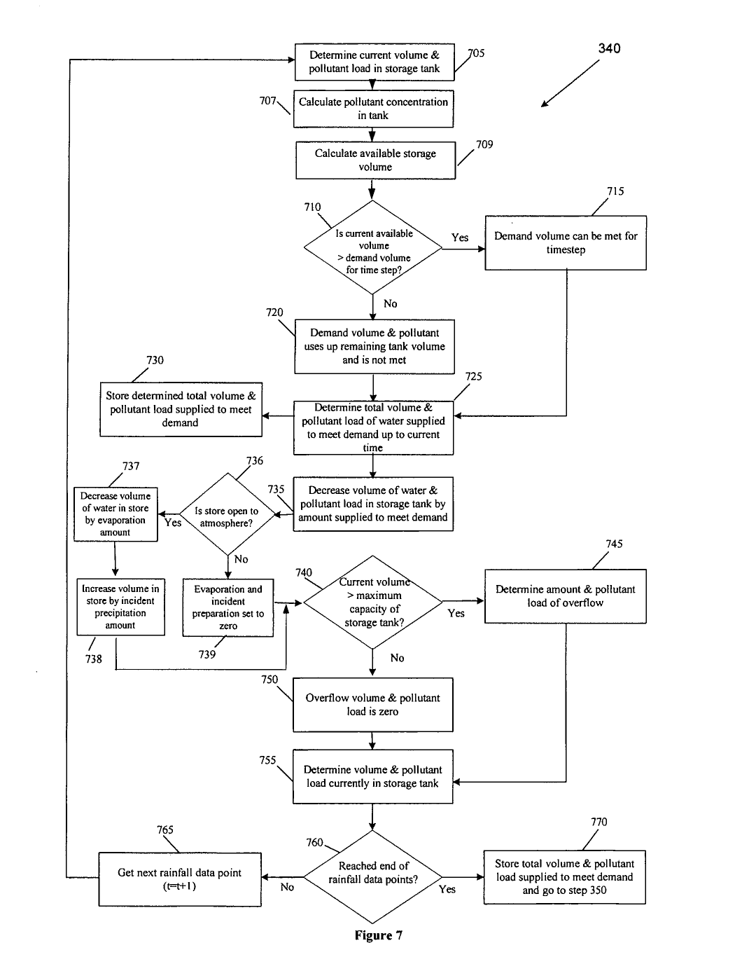

At step 340, the storage efficiency of storage system 50 is determined by storage behaviour module 250. This determination is made on the basis of factors such as the stored water volume 56 in storage tank 52, the supply 60 required to meet demand and the maximum capacity of the storage tank 52, for example. Step 340 is described in further detail below, with reference to FIG. 7.

At step 350, the determinations made at steps 320 to 340 are stored in memory 130. Steps 320 to 350 may be considered to be a model generation process, by which a model of system 10 is generated according to a specific set of modelling parameters.

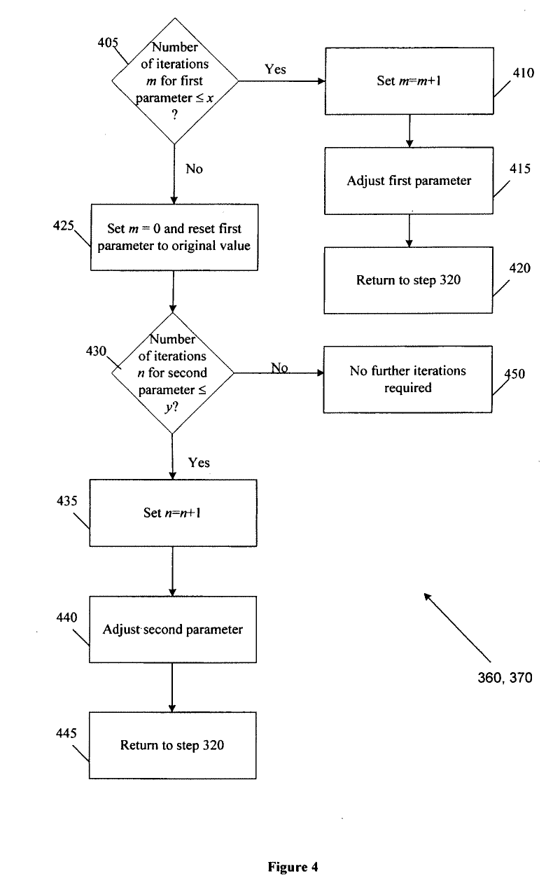

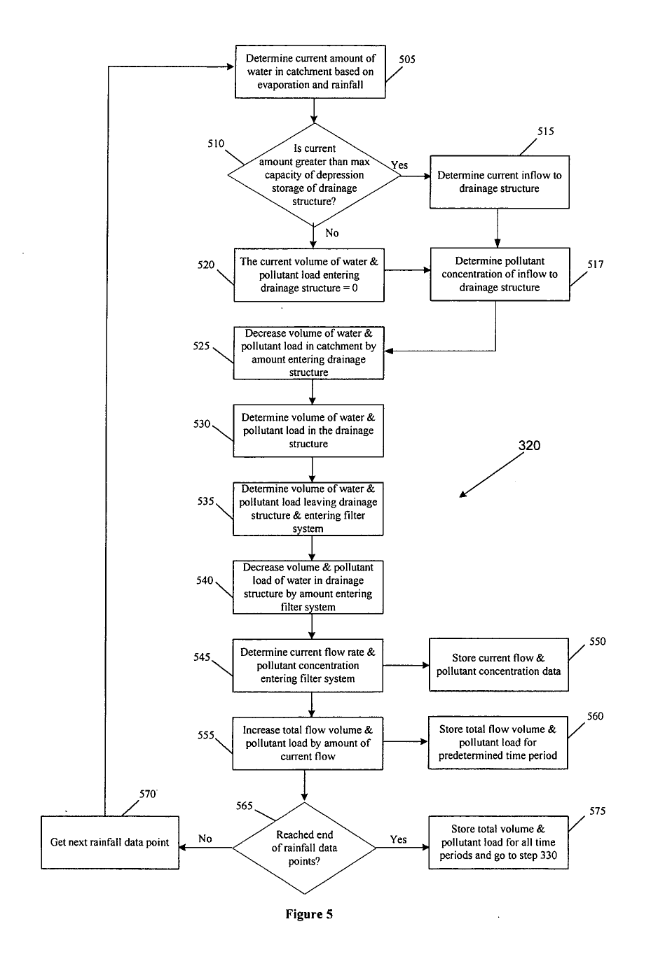

At step 360, processor 120 executes iteration module 220 to check whether any further iterations are required and, if so, at step 370 adjusts a parameter, for example, the storage size or filter area or another parameter, as described above. Rainfall runoff module 230, filter efficiency module 240 and storage behaviour module 250 are then executed to perform steps 320 to 350 again based on the adjusted parameter. Iteration and adjustment steps 360 and 370 are described in further detail below, with reference to FIG. 4.

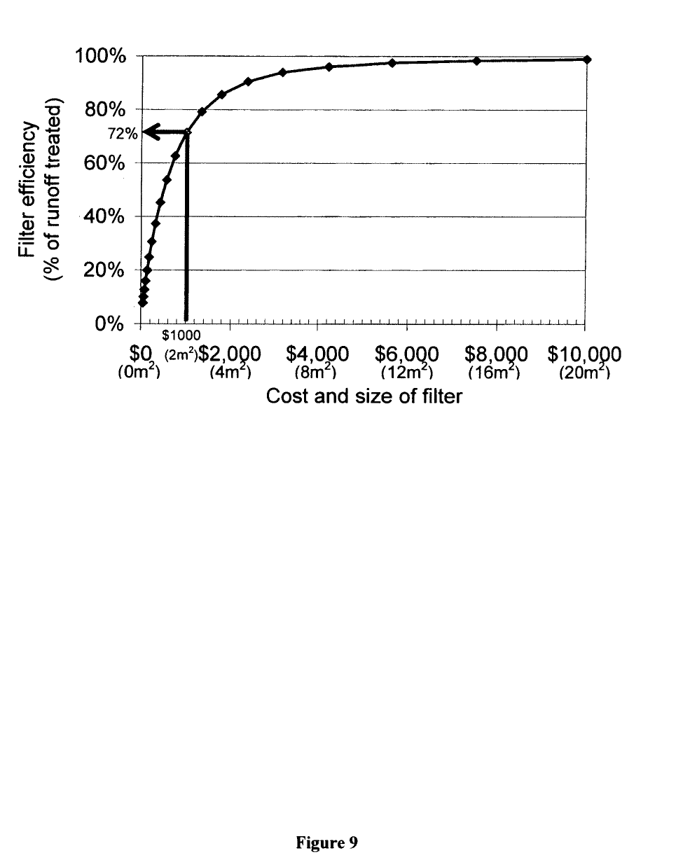

Once iteration module 220 determines at step 360 that no further iterations are required, this is communicated to decision support module 260, which interacts with user interface module 210 to generate one or more reports at step 380 relating to the generated water harvesting system modules. Such reports may include, for example, one or more plots or graphs that show relationships between cost, tank size, filter area and/or percentage of water demand met by the supply. These reports may be used by a person to decide upon a water harvesting system that has a configuration optimised for one or more particular purposes. Example plots included in such reports are shown in FIGS. 9, 10 and 11, which are described in further detail below.

Referring now to FIG. 4, an example process to perform steps 360 and 370 is shown in further detail. At step 405, iteration module 220 determines whether an iteration limit, x, for a first parameter, for example for filter size modifications, has been exceeded. This determination is completed by comparing the number m of first parameter modifications already completed during the current simulation with the defined iteration limit (i.e. maximum number of modifications). The first parameter iteration limit may be one of the initial configuration parameters received at step 305 as input or may be pre-configured and stored in memory 130. If at step 405 the first parameter iteration limit has not been exceeded, then iteration module 220 proceeds to step 410. Otherwise, iteration module 220 proceeds to step 425.

At step 410, iteration module 220 increments the number m of first parameter modifications currently completed in the current simulation by 1. This can then be used to determine at step 405 whether the first parameter iteration limit x has been exceeded.

At step 415, iteration module 220 alters (e.g. reduces, increases or changes) the first parameter, which may be, for example, the filter area size of filter media 36. The adjusted first parameter (e.g. new filter area size) is set to, for example, 75% of the previous parameter value. This new parameter value is then used for generating the next model of system 10.

The iterative adjustment of the first parameter is for the purpose of being able to generate reports for comparative analysis of different models of system 10. Thus, the number of models generated according to method 300 depends on the number of iterations in which the first parameter is adjusted, which may be set by the iteration limit, x. Thus, if the filter size is adjusted by reducing it by 75% per iteration, for example, this assumes a large filter size as a starting point. The first parameter may be reduced or increased at each iteration by a fixed percentage, for example between 10% and 90%, or a varying percentage. If the adjustment is a reduction, the reduction percentage of the first parameter should be greater than zero, but less than 100%.

As an alternative to reducing the first parameter from a large value, the first parameter may be increased over a number of iterations from a small value. Thus, if the first parameter represents filter area, the filter area may start off at about 0.5 m² and increase each iteration by 100% over, say, 20 iterations (i.e. x=20).

At step 420, iteration module 220 returns process control to rainfall runoff module 230 to determine the rainfall runoff at step 320.

At step 425, iteration module 220 sets the number of first parameter modifications m back to zero to start the modification process again. Also at step 425, the current value of the first parameter is reset to the original value of the first parameter determined at step 305.

At step 430, the iteration module determines whether an iteration limit y for a second parameter, for example tank size, has been exceeded. This is determined by comparing the number n of second parameter modifications already completed within the current simulation with the defined second parameter iteration limit y. The second parameter iteration limit y may be one of the initial configuration parameters received at step 305 as input or may be pre-configured and stored in memory 130. If at step 430 the second parameter iteration limit y has been exceeded, then at step 450 iteration module 220 determines that no further iterations are required. Otherwise, iteration module 220 proceeds to step 435.

At step 435, iteration module 220 increments the number n of second parameter modifications currently completed in the simulation by 1. This is used to determine at step 430 whether the second parameter iteration limit y has been exceeded.

At step 440, iteration module 220 adjusts (i.e. increases, reduces or changes) the second parameter. This adjustment may be calculated by decreasing or increasing the current tank size by, for example, 50%. The iterative adjustment of the second parameter is for the purpose of being able to generate reports for comparative analysis of different models of system 10. Thus, the number of models generated according to method 300 depends on the number of iterations in which the second parameter is adjusted, which is set by the iteration limit, y. Thus, if the tank size is adjusted by reducing it by 50% per iteration, for example, this assumes a large tank size as a starting point. The second parameter may be reduced or increased at each iteration by a fixed percentage, for example between 10% and 90%, or a varying percentage. If the adjustment is a reduction, the reduction percentage of the tank size should be greater than zero, but less than 100%.

As an alternative to reducing the second parameter from a large value, the value of the second parameter may be increased over a number of iterations from a small value. Thus, if the second parameter represents tank size, the tank size may start off at about 1 m³ and increase each iteration by 50% over, say, 20 iterations (i.e. y=20).

The first and second parameter iteration limits x and y may be selected to be different or the same and may each have a value in the range 3 to 100, for example.

At step 445, the iteration module 220 returns process control to rainfall runoff module 230 to determine the rainfall runoff at step 320.

Instead of adjusting filter area or tank size, other configurable system parameters may be adjusted as part of the iteration process. For example, a flow rate through the filter media may be used as an adjustable parameter during the iteration process. As a further alternative, the volume of the pondage store 32 may be used as an adjustable parameter during the iteration process. Further example parameters are described above in relation to iteration module 220. Depending on limits of computing capacity and efficiency, three, four, five or more parameters may be iteratively adjusted together to provide enhanced reporting functionality to the user.

For some parameters, for example such as storage tank type or material, adjustment may involve selecting a next enumerated item in a list (e.g. of possible types or materials), rather than an increase or decrease. In this case, the iteration limit may be fixed according to the number of enumerated list items in the list.

Referring now to FIG. 5, a process to perform step 320 is shown and described in further detail. At step 505, the rainfall-runoff module 230 determines the current volume and quality of water which is currently within the catchment area defined by the input received at step 305 (i.e. the amount of water in the catchment 15). This determination is based upon addition of the current volume of rainfall on the catchment (determined as a function of the area of catchment 15 and the measured rainfall volume per unit area for the current time step) and the volume and quality of water which was determined to be in the catchment in the previous timestep, if there was a previous timestep. Also at step 505, the current volume of water in the catchment is decreased by a volume of water which is lost from the system due to evaporation. This volume is determined as a function of the area of catchment 15 and the historical measured or estimated evaporation volume per unit area for the current time-step.

At step 510, the rainfall runoff module 230 determines if the volume of water currently in the catchment 15 (determined in step 505) is greater than the maximum capacity of the depression storage in the catchment 15 and drainage structure 20. The maximum capacity of the depression storage of the catchment 15, or the volume of water which does not become runoff during the initial stages of an event, is one of the initial configuration parameters received at step 305.

At step 515, if there is a positive determination (yes) at step 510 then rainfall runoff module 230 calculates the current volume which leaves the catchment area 15 and enters the drainage structure 20. The inflow volume to the drainage structure 20 is the difference between the volume of water currently in the catchment and the maximum capacity of the depression storage.

At step 517, rainfall runoff module 230 determines the quality of the water which enters the drainage system 20. This water quality can be described by two terminologies: (1) pollutant concentrations, which are a measure of the amount or mass of a pollutant per unit volume of water (e.g. concentrations are usually reported as milligrams per litre [mg/L] or for pathogens as no./100 ml) or (2) pollutant loads which are a measure of the total amount or mass of a pollutant (e.g. loads are usually reported as milligrams [mg] for solids, etc. or total numbers for pathogens). The following descriptions will use both of these terms. At step 517, the concentration of pollutants (e.g. mg/L) (including but not limited to solids, nutrients, heavy metals, hydrocarbons and pathogens) may be predicted by one of three methods: (i) application of a static mean value; (ii) stochastic generation based on a defined mean and standard deviation of concentration; and (iii) calculation of concentration as a function of variables such as rainfall intensity, flow rate and catchment type, along with buildup and washoff processes. At any time during the simulation, this pollutant concentration can be converted to a pollutant load by using the product of this concentration and the respective volume of water.

At step 520, if there is a negative determination (no) at step 510, then rainfall runoff module 230 calculates the current inflow volume received to drainage structure 20 as zero. Furthermore, the concentration and load (e.g. mass) of pollutants entering the drainage structure 20 are also determined to be zero.

At step 525, the rainfall runoff module 230 decreases the volume of water and pollutant load currently in the catchment (determined at step 505) by the volume of water and pollutant load which was received into the drainage system (determined at step 515 or 520, depending on the outcome of step 510).

At step 530, the rainfall runoff module 230 determines the volume of water and pollutant load which is currently within the drainage structure 20. This determination is made by adding the volume of water and pollutant load which enters the drainage system during the current timestep (determined at step 515 or 520) to the volume of water and pollutant load which was in the drainage structure 20 in the previous timestep (calculated at step 540), if there was a previous timestep.

At step 535, the rainfall-runoff module 230 determines the volume of water and pollutant load which leaves the drainage structure 20 and enters the filter system 30 in step 605 (FIG. 6). This determination is based upon the current volume of water and pollutant load in the drainage structure (determined at step 530) which is multiplied by a defined percentage (between 0% and 100%). This percentage, which may be referred to as a routing coefficient, is one of the initial configuration parameters received at step 305.

At step 540, the rainfall runoff module 230 determines the amount of water and pollutant load currently in the drainage structure 20. This is determined by subtracting the volume of water and pollutant load leaving the drainage structure (determined in step 535) from the volume of water and pollutant load within the drainage structure (determined in step 530).

At step 545, the rainfall runoff module 230 determines the flow rate (i.e. a volume [litres] per unit of time [seconds]) and pollutant concentration of water which enters the filter system at step 605. This is determined by using the volume and pollutant load determined in step 535 and converting the volume to a flow rate using conversion factors and the load to a concentration calculated from ratio of load to volume. At step 550, rainfall runoff module 230 stores the flow rate and pollutant concentration entering the filter system into the memory 130.

At step 555, rainfall runoff module 230 increases the total flow volume and total pollutant load by the amount calculated in step 535. This total flow volume and pollutant load represents the total volume of water and pollutant load (respectively) which has left the catchment area 15 and the drainage structure 20 and has proceeded to the filter system 30. At step 560, rainfall runoff module 230 stores this total flow volume and pollutant load into memory 130 which represents the total flow volume and pollutant load delivered to the filter system 30 up to the current timestep.

If at step 565 there are more rainfall data points, then the rainfall runoff module 230 gets the next data point and timestep from the rainfall data 235 (and accesses the information passed on from the input 305, if necessary) and proceeds to repeat step 505 for the next data point. If it is determined at Step 565 that there are no more data points to be processed, then at step 575 the rainfall runoff module 230 stores the overall total volume of water and pollutant load which has been produced by the catchment area 15 and drainage structure 20 for all time periods in memory 130. This total volume of water and pollutant load provides an estimate of the total volume of water and pollutant load (respectively) which the catchment has produced during the simulation period.

Referring now to FIG. 6, a process to perform step 330 is shown and described in further detail. At step 605, the filter efficiency module 240 determines the current volume of water and pollutant load which is currently in the water store located on top of the filter (i.e. the amount of water in the pondage store 32). This determination is based upon addition of the current inflow determined by the rainfall runoff module 230 (determined in step 550) and the volume of water which was determined to be in the ponding store in the previous timestep (if there was a previous timestep). At Step 607, the pollutant concentration is calculated from the pollutant load using the current water volume.

At step 610, the filter efficiency module 240 determines whether the current volume of water in the pondage store 32 is greater than what the filter media 36 is capable of processing during the current timestep. The maximum capacity of the filter media 36 during the current timestep, or the volume of water which can be treated by the filter media 36 during the current timestep, is a function of the maximum initial capacity of the filter media (which is one of the initial configuration parameters received at step 305) and the amount of water previously received by the filter media 36. This maximum capacity will tend to change as the amount of water previously received by the filter increases.

The equation used to describe the hydraulic degradation of the filter media (i.e. an equation which can describe how the filter capacity decreases with time) may take the form of a negative exponential function, such that: Current Filter Capacity=Initial (or maximum) Filter Capacity*e^{-X}*^{total amount of water fed through the filter}+Y (where X and Y are both adjustable constants). However, it should be noted that this is only one of a number of possible functions which could be used.

At step 615, if there is a positive determination (yes) at step 610, then the volume of water and pollutant load processed by the filter media 36 is limited to its current maximum capacity. At step 620, if there is a negative determination (no) at step 610, then the volume of water processed by the filter media 36 is equal to the amount of water currently within the pondage store 32. At step 617, the concentration of pollutants in the water passing through the filter media 36 are reduced as a function of the inflow concentration (obtained from step 550), the flow rate, the filter moisture content and the amount of water previously received by the filter media. Coefficients of this function can be adjusted based on a filter-type input parameter. The concentration of pollutants will reduce also as a function of total water which has been treated by the filter media. So the treatment of the media may increase or decrease as the filter ages.

The outflow concentration from the filter media is a simple fixed proportion of the inflow pollutant concentration, such that: Cₒᵤₜ=X*Cᵢₙ (where X is some fixed percentage, and this value will depend on the type of constituent). X also depends on the current filtering capacity of the filter media, as determined above. There may be a minimum limit to the Cₒᵤₜ value, such that the filter efficiency module 240 determines whether Cₒᵤₜ is <Y (which is some value set for a pollutant) and if Cₒᵤₜ is less than this value Y, then Cₒᵤₜ is set to Y for that timestep. This is because even when passing through clean water, there will usually still be some level of pollutants (e.g. sediment) exiting the system. It should be noted again that this is one of a number of mathematical functions which could be used here.

At step 625, the filter efficiency module 240 determines the current flow rate and quality of water which was processed by the filter media 36 during the period of the timestep Δt. This is determined using the processed water volume determined in either step 615 or 620, and the pollutant concentration determined in step 617. The current flow rate represents the volume of water [litres] processed by the filter media 36 per unit of time [seconds].

At step 630, the current flow rate of water and pollutant concentration are calculated in step 625 is stored in memory 130. This is used by storage behaviour module 250 in step 705 to determine the flow rate and quality of water entering the storage system 50. At step 635, the filter efficiency module 240 increases the total flow volume of water and total pollutant load (the product of pollutant concentration and water flow) which has been processed by the filter media 36 during the current simulation by the amount determined in step 625. This flow volume and pollutant load is used to determine the total amount of water and pollutant load which has been treated by the filter system 50. At step 640, the total flow volume and pollutant load up to the current timestep determined in step 635 is stored into memory 130.

At step 645, the filter efficiency module 240 decreases the volume of water and pollutant load which is currently in the ponding store (calculated at step 605) by the volume of water and pollutant load which has been filtered by the filter media 36 during the current timestep (calculated at step 615 and step 620, depending on the outcome of step 610).

At step 650, the filter efficiency module 240 determines whether the ponding store volume currently exceeds the maximum pondage store volume which was input in step 305. This is to ensure that the maximum amount of water allowed in the pondage store 32 is not exceeded, and if it is exceeded, then this amount of water is determined to be lost from the system 10 and bypasses the filter system 30. At step 655, if a positive determination (yes) is made at step 650, then filter efficiency module 240 determines the current volume of water which is lost from the system (which is equal to the difference between the maximum amount of water allowed in pondage store 32 and the current ponding store volume). The amount of pollutant load lost from the system at this step is calculated as the product of the pollutant concentration currently in the pondage store and the volume of water lost from the system. At step 660, if a negative determination (no) is made at step 650, then filter efficiency module 240 sets the current volume of water and pollutant load which is lost from the system as zero.

At step 665, the filter efficiency module 240 decreases the volume of water and pollutant load which is currently in the pondage store 32 by the amount of water and pollutant load which was determined to have been lost from the system.

At step 670, filter efficiency module 240 determines whether the last data point from the outputs of the rainfall module 230 (determined in step 320) has been processed (i.e. whether the simulation reached the end of the time series required to be analysed). At step 675, if there is one or more data points remaining, then filter efficiency module 240 gets the next data point and timestep from the information passed on from the rainfall module 230 and proceeds to repeat steps 605 to 670 for the next data point.

If it is determined at step 670 that there are no more data points to be processed, then at step 680, the filter efficiency module 240 stores the overall total volume of water and pollutant load which has been processed by the filter system 30 for all time periods. This total volume of water and pollutant load provides an estimate of the total volume of water and pollutant load which the filter system 30 was able to treat during the simulation period.

Referring now to FIG. 7, step 340 is shown and described in further detail. At step 705, storage behaviour module 250 determines the volume of water and pollutant load which is currently in the storage tank 52. This volume and pollutant load is determined by the addition of the volume of water and pollutant load which was in the storage tank 52 in the previous timestep (if there was a previous timestep) and the volume and pollutant load of filtered water which enters the store from the filter (calculated in Step 630).

At step 707, pollutant concentrations (calculated from the pollutant load and volume in the tank) are reduced (or increased) as a function of the current pollutant concentration, current volume of water in the tank, the length of time that the water has been located within the tank and climatic characteristics (including ambient temperatures which is represented by climatic data 237 received as input). Coefficients of this function can be adjusted to account for the tank-type (e.g. plastic, steel, closed vs. open) and tank size.

At step 709, the storage behaviour module 250 calculates the amount of available water volume within the store as the difference between the amount of water in the store and the residual storage volume 57. The residual storage volume 57 is the amount of water which cannot be removed from the store for any end use and must remain in the store to provide, for example, amenity. The residual storage volume 57 is given as a zero or positive valued input to user interface 140 at step 305.

At step 710, the storage behaviour module 250 determines whether the available volume of water currently in the storage tank 52 (from step 709) is greater than the current (instantaneous) volume of demand which is required from the storage tank 52 during this timestep (as determined in step 305). This allows the storage behaviour module 250 to determine whether the specified demand volume (i.e. for toilet flushing, garden irrigation etc) can be supplied by the storage tank 52, or whether only a portion of this demand can be supplied. At step 715, if the instantaneous demand does not exceed the available stored volume 56 (from step 709), then the entire instantaneous water demand volume 60 can be supplied from the stored water volume 56 for the current timestep. Otherwise, at step 720, only the volume of water 56 which is available in the store can be supplied to meet the current demand 60.

At step 725, the storage behaviour module 250 determines the total volume of water and pollutant load which has been supplied to meet the demand from the store for the entire simulation up to the current time t. At step 730, the total volume of water supplied and pollutant load to meet the demand determined in step 725 is stored in memory 130. This volume of water can be used to determine the total amount of water which has been supplied to meet the demand. At step 735, the storage behaviour module 250 decreased the volume of water and pollutant load in the store (calculated in step 705) by subtracting the volume of water and pollutant load which was supplied to meet the current demand 60 (calculated in step 715 or 720).

If a positive determination is made at step 736, then at step 737 the storage behaviour module 250 decreases the volume of water in the store (calculated in step 735) by subtracting the volume of water which was lost to the atmosphere due to evaporation (which is calculated as the product of the evaporation rate, provided as input to the model at step 305, and the surface area of the storage, also provided as input to the model at step 305). At step 738, the volume of water in the store is increased by the amount of incident precipitation on exposed area of the open store. This is calculated as the product of the current rainfall rate (from 235) and the surface area of the open store (provided as an input parameter at step 305).

If a negative determination is made at step 736, then at step 739 the storage behaviour module 250 sets the amount of incident evaporation and precipitation to zero.

At step 740, the storage behaviour module 250 determines whether the volume of water currently in the store (from step 735 or step 738 if it is an open store) is greater than the maximum capacity of the storage tank 52 (determined from step 305). This allows the storage behaviour module 250 to determine whether some water (and therefore pollutant load) supplied to the storage system 50 from the filter system 30 is lost from the system 10 and the store overflows because the storage tank 52 has reached its capacity. At step 745, if the maximum capacity is exceeded, then the storage behaviour module 250 calculates the volume of water which overflows from the store by subtracting the maximum storage volume (determined in step 305) from the current store volume (calculated in step 735). At this same step, the total pollutant load which overflows is calculated using the product of the pollutant concentration currently in the store and the volume of water 54 which overflows. Otherwise. at step 750, the volume and pollutant load of water which overflows from the store is set to zero.

At step 755, the storage behaviour module 250 determines the water and pollutant load currently in the storage system 50 once the overflow from the storage tank 52 has occurred. This is determined by subtracting the overflow volume and pollutant load calculated in steps 745 or 750 from the store volume and pollutant load determined in step 735 or step 738.

At step 760, the storage behaviour module 250 determines whether the last data point from the outputs of the filter efficiency module 240 (determined in step 330) has been processed (i.e. whether the simulation has reached the end of the time series required to be analysed). At step 765, if there is one or more data points remaining, then storage behaviour module 250 gets the next data point and timestep from the information passed on from the filter efficiency module 240 and proceeds to repeat Step 705 for the next data point. Otherwise, at step 770, storage behaviour module 250 then stores in memory 130 the overall total volume of water and pollutant load which was supplied to meet the demand from the store. This provides an estimate of the total volume of water which would have been harvested by the water harvesting system (according to the presently configured model) during the simulation period.

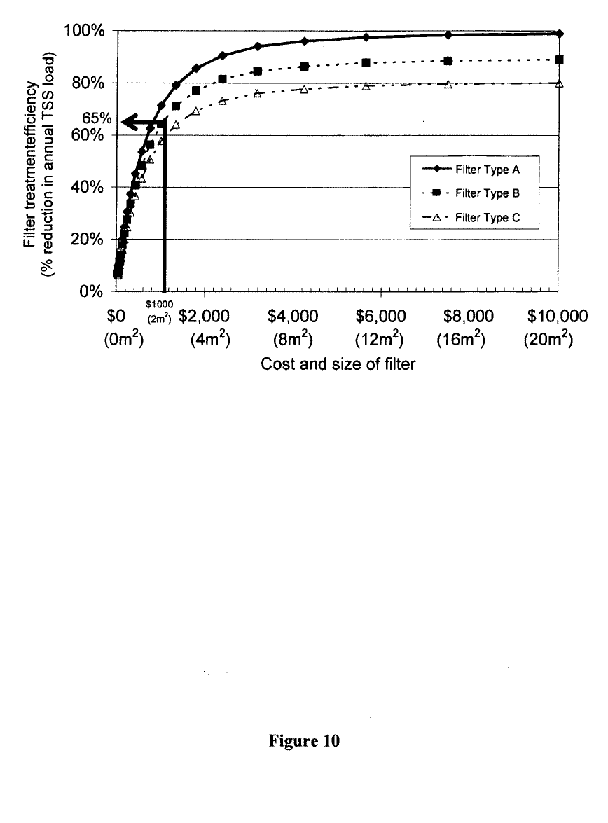

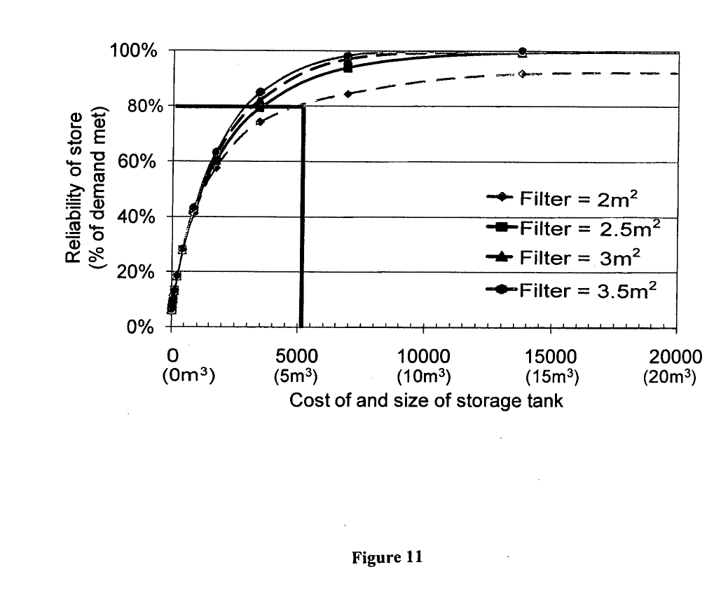

The reports generated at step 380 may be useful for a user of system 100 in determining an optimised configuration for water treatment and harvesting system 10, as such reports enable a comparative analysis of different system configurations, including estimated cost associated with some such configurations. As is illustrated in the plots of the filter size versus efficiency in FIG. 9, filter treatment efficiency versus filter size in FIG. 10 and tank size versus percentage of demand met in FIG. 11, a user of system 100 can select a starting point, such as a cost point, filter size, tank size, desired filter processing or treatment efficiency or percentage of demand met and then readily determine the implications of such a selection on other configuration and/or cost parameters associated with the user's selection.

Each of the data points illustrated in the plots of FIGS. 9, 10 and 11 (from which the relationships of the parameters are extrapolated as curves) corresponds to a specific model generated by system 100 as part of process 300.

In the examples shown in FIGS. 9, 10 and 11, an example budget of $6000 is made available to purchase a water harvesting and treatment system ($1000 available for a filter system 30 and $5000 for a storage system 50). Referring now to FIG. 9, the results indicate that a $1000 filter system (which provides 2 m² of filter media 36) can treat approximately 72% of the runoff from the catchment. This type of information is important to enable a user to understand how much of the water which flows from the catchment is delivered to the storage tank 52. In this scenario, around 28% of the water is not delivered to the tank. If 72% is not considered to be a sufficient capture efficiency, the user can choose to select a filter that treats almost all the water from the catchment, although the increase in capture efficiency may not be worth the extra costs involved. In the scenario shown in FIG. 9, the user would need to install a larger $10000 storage system 50 to treat 99% of the water from the catchment. The 10-fold increase in cost only results in an increase in filter efficiency of 27%.

FIG. 10 is a plot of example modelled parameters of a water treatment and harvesting system, illustrating pollutant load reduction versus filter size and cost, for three different filter types, for a range of sizes. The plot of FIG. 10 allows the user to choose both the appropriate size and type of filter, based on a selected pollutant reduction target. In the example shown, the user has selected to achieve a total suspended solids (TSS) reduction of 65%, and chose Filter Type B (the example assumes that each filter type is the same cost per m², but this may not always be the case), giving a required filter area of 2 m². A similar plot can be produced for each pollutant parameter (e.g. sediment, nutrients, pathogens, heavy metals and hydrocarbons), depending on the user's requirements.

Referring now to FIG. 11, the results of this specific scenario indicate that a $5000 tank would be able to meet 80% of the user-defined demand when using a 2 m² filter. If the user wants to increase this reliability, the user may decide to either increase the size of the storage tank 52 or increase the filter size. For example, if the user wanted to increase the reliability of the tank by 10% to 90%, the user may chose to either: (1) increase the filter area to 3 m² which increases the overall costs by $500 or (2) purchase a $10,000 tank which increases the overall costs by $5000. In some situations, the demand may be higher than the amount of rainfall (for that geographic location) can supply, in which case, the user may be presented with a report indicating that, for example, a maximum of 80% of demand can be met, regardless of filter size, tank size or other parameters.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Modifications or enhancements to the embodiments may be apparent to those skilled in the art without departing from the spirit of the embodiments as hereinbefore described with reference to the accompanying drawings. The described embodiments are therefore intended to be exemplary and non-limiting when considered in the context of the appended claims.

1. A method of modelling a water treatment and harvesting system, the method comprising:
receiving modelling data, the modelling data comprising a plurality of parameters relating to intended application of the water treatment and harvesting system;
accessing rainfall data for a geographic region for a predetermined historical period, the rainfall data comprising data for a plurality of predetermined time points over the historical period; and
generating a model of the water treatment and harvesting system based on the rainfall data and the modelling data

2. The method of claim 1, further comprising:
automatically adjusting at least one parameter of the modelling data; and
generating a next model of the water harvesting system based on the rainfall data and the modelling data.

3. The method of claim 2, wherein the adjusting and the generating a next model are performed repeatedly a predetermined number of times.

4. The method of claim 2 or claim 3, wherein the plurality of parameters comprise a first parameter and a second parameter and wherein the adjusting comprises adjusting one of the first parameter and the second parameter.

5. The method of claim 4, wherein the adjusting and generating comprise adjusting the first parameter and generating a next model based on the adjusted first parameter for a first predetermined number of iterations and then adjusting the second parameter and generating a next model based on the adjusted second parameter.

6. The method of claim 5, wherein the adjusting of the second parameter and the generating a next model are performed for a second predetermined number of iterations.

7. The method of claim 6, wherein the first predetermined number of iterations is performed for each of the second predetermined number of iterations.

8. The method of claim 4, wherein the first and second parameters are selected from: a filter area; a storage structure size; a filtration rate; a pondage store volume; a storage structure type; an area of storage structure open to atmosphere; a relative imperviousness of a catchment area; a rainfall routing coefficient; a residual storage volume; a demand magnitude; and a demand pattern.

9. The method of claim 1, wherein the model is generated based on an urbanised water catchment area.

10. The method of claim 9, wherein the urbanised water catchment area comprises a relatively high proportion of impervious surfaces.

11. The method of claim 10, wherein the proportion of impervious surfaces comprises greater than 5% for the catchment area.

12. The method of claim 1, wherein the generating comprises determining flow and pollutant concentrations for rainfall modelled to be received at the treatment and harvesting system at each time point.

13. The method of claim 1, wherein the generating comprises determining capture and treatment efficiency for rainfall modelled to be received at a filter of the treatment and harvesting system at each time point.

14. The method of claim 1, wherein the generating comprises determining a storage efficiency of a water storage structure of the treatment and harvesting system.

15. The method of claim 1, further comprising displaying a comparative display of the model and at least one next model generated based on the same rainfall data.

16. The method of claim 15, wherein the comparative display comprises at least one of
a comparison of filter cost and filter efficiency;
a comparison of filter size and filter efficiency;
a comparison of storage structure cost and storage reliability/efficiency; and
a comparison of storage structure size and storage reliability/efficiency.

17. The method of claim 1, wherein the model is generated based on climatic data and the modelling data, wherein the climatic data comprises the rainfall data and other climatic data for the same predetermined time points.

18. Computer readable storage storing computer program code which, when executed by at least one processor, causes the at least one processor to perform the method of claim 1.

19. The computer readable storage of claim 18, further storing the rainfall data.

20. The computer readable storage of claim 18 or claim 19, further storing at least some of the plurality of parameters.

21. A modelling system for modelling a water treatment and harvesting system, the modelling system comprising:
an interface to receive modelling data comprising a plurality of parameters relating to intended application of the water treatment and harvesting system;
at least one processing device having access to the modelling data and access to rainfall data for a geographic region for a predetermined historical period, the rainfall data comprising data for a plurality of predetermined time points over the historical period; and
computer readable storage storing program code executable by the at least one processor for causing the at least one processor to generate a model of the water treatment and harvesting system based on the rainfall data and the modelling. data.

22. The system of claim 21, wherein the program code comprises code which, when executed by the at least one processor, causes the at least one processor to:
automatically adjust at least one parameter of the modelling data; and
generate a next model of the water harvesting system based on the rainfall data 10 and the modelling data.

23. The system of claim 22, wherein the adjusting and the generating a next model are performed repeatedly a predetermined number of times.

24. The system of claim 22 or claim 23, wherein the plurality of parameters comprise a first parameter and a second parameter and wherein the adjusting comprises adjusting one of the first parameter and the second parameter.

25. The system of claim 24, wherein the adjusting and generating comprise adjusting the first parameter and generating a next model based on the adjusted first parameter for a first predetermined number of iterations and then adjusting the second parameter and generating a next model based on the adjusted second parameter.

26. The system of claim 25, wherein the adjusting of the second parameter and the generating a next model are performed for a second predetermined number of iterations.

27. The system of claim 26, wherein the first predetermined number of iterations is performed for each of the second predetermined number of iterations.

28. The system of claim 24, wherein the first and second parameters are selected from: a filter area; a storage structure size; a filtration rate; a pondage store volume; a storage structure type; an area of storage structure open to atmosphere; a relative imperviousness of a catchment area; a rainfall routing coefficient; a residual storage volume; a demand magnitude; and a demand pattern.

29. The system of claim 21, wherein the interface is responsive to the at least one processor to display a comparative display of the model and at least one next model generated based on the same rainfall data.

30. The system of claim 19, wherein the comparative display comprises at least one of:
a comparison of filter cost and filter efficiency; a comparison of filter size and filter efficiency;
a comparison of storage structure cost and storage reliability/efficiency; and
a comparison of storage structure size and storage reliability/efficiency.
